(19) United States
(12) Patent Application Publication
(10) Pub. No.: US 2026/0368091 A1
(43) Pub. Date: Nov. 19, 2026

(54) MULTIPLE STREAM SEAMLESS READ

(71) Applicant: Micron Technology, Inc,, Boise, ID (US)

(72) Inventors: Xiangyu Tang, San Jose, CA (US); Roy Leonard, San Jose, CA (US); Eric N. Lee, San Jose, CA (US); Kishore Kumar Muchherla, San Jose, CA (US); Akira Goda, Tokyo (JP)

(21) Appl. No.: 19/209,276

(22) Filed: May 15, 2025

(51) Int. Cl. G06F 12/0802

(52) U.S. Cl. CPC G06F 12/0802; G06F 2212/603

(57) ABSTRACT

A system comprising a memory device with a seamless cache read (SCR) mode, where the SCR mode maintains a wordline in a ramped-up state for sequential read commands directed to that line. A processing device, coupled to the memory device, identifies and tracks multiple concurrent sequential read streams and determines if any of these streams satisfy a condition for activating the SCR mode. If a condition is satisfied, the processing device controls the activation of the SCR mode for the identified stream, optimizing memory performance and power efficiency.

### TECHNICAL FIELD

This disclosure relates to controlling a seamless cache read (SCR) mode in a memory device based on concurrent read streams.

### BACKGROUND

A memory sub-system can include one or more memory devices that store data. The memory devices can be, for example, nonvolatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 is an SCR mode diagram, in accordance with some examples.

FIG. 3 is a diagram of operations performed by the SCR control system, in accordance with some examples.

FIG. 4 is a diagram of operations performed by the SCR control system, in accordance with some examples.

FIG. 5 is a diagram of operations performed by the SCR control system, in accordance with some examples.

FIG. 6 illustrates a flowchart of operations performed using the SCR control system, in accordance with some examples.

FIG. 7 is a block diagram of an example computer system, in accordance with some examples.

### DETAILED DESCRIPTION

The present disclosure configures or programs a memory sub-system to perform multi-stream seamless cache read (SCR) operations for sequential data commands, such as for machine learning (ML) model loading and/or inferencing. The present disclosure provides a hardware and/or firmware-based solution for optimizing sequential read operations in memory sub-systems, such as solid-state drives (SSDs), by identifying and tracking multiple concurrent sequential read streams and enabling an SCR mode to maintain wordlines (WLs) or WL groups (WLGs) in a ramped-up state. The multi-stream seamless read system supports any combination of three implementation approaches. These approaches include a NAND firmware implementation that identifies and tracks concurrent sequential streams, an ASIC controller implementation that de-interleaves and reorders multi-stream sequential reads, and/or a hybrid implementation where the ASIC identifies streams while the NAND firmware maintains the SCR mode. When multiple interleaved sequential streams are received, the system enables optimized reading by maintaining WL voltage levels for sequential accesses, reducing overhead between reads to the same WL while still allowing some random read commands within the interleaved sequential read streams. This hardware and firmware-based approach significantly improves read bandwidth, which improves the overall efficiency of the memory sub-system.

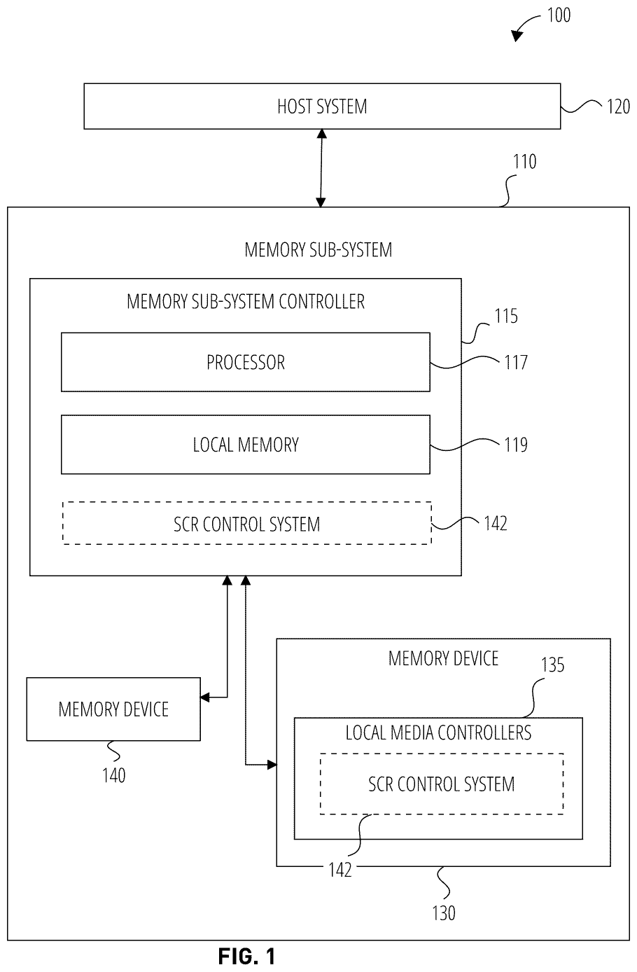

A memory sub-system can be a storage device, a memory module (memory component), or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

The memory sub-system can initiate media management operations, such as a write operation, on host data that is stored on a memory device. In some examples, firmware of the memory sub-system may rewrite previously written host data from a location on a memory device to a new location as part of garbage collection management operations. A memory device can be a nonvolatile memory device. A nonvolatile memory device is a package of one or more dice (or dies). Each die can be comprised of one or more planes. For some types of nonvolatile memory devices (e.g., NAND devices), each plane is comprised of a set of physical blocks. For some memory devices, blocks are the smallest areas that can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

Conventional memory systems perform read operations in an inefficient manner that wastes both time and power resources. For each read operation to a WL, conventional memory systems usually execute a series of overhead operations including initialization (e.g., a prologue and voltage pass ramp) and recovery procedures. When reading multiple pages from the same WL, such as lower page (LP), upper page (UP), and extra page (XP) locations, the conventional memory systems redundantly perform these overhead operations between each read, unnecessarily ramping the WL voltage up and down multiple times.

The limitations of conventional systems are particularly evident in scenarios with multiple concurrent sequential read streams, such as artificial intelligence (AI) ML model loading. Such conventional memory systems can only detect and optimize for simple sequential access patterns, being unable to maintain efficient operation when sequential reads are interrupted or interleaved with random read commands. When multiple streams access the same WL or WLG in an interleaved fashion, the conventional memory systems treat these as random or non-sequential accesses, forcing the memory systems to perform the full overhead operations between each read even though the accesses are actually part of sequential patterns.

Furthermore, conventional memory systems lack intelligent mechanisms for managing read operations across multiple blocks and WLs. The rigid detection of sequential patterns means that even slight deviations, such as occasional reads to different WLs or memory blocks and/or sub-blocks (SBs), force the conventional memory systems to abandon any efficiency optimizations. This results in significant performance penalties, especially for workloads like AI inferencing that involve large volumes of data being read from multiple streams simultaneously while following generally sequential but occasionally interrupted patterns.

The present disclosure addresses these technical challenges by implementing a multi stream SCR system that provides several distinct approaches (yet combinable) for optimizing sequential read operations. In one approach, a NAND (e.g., memory device) firmware implementation identifies and tracks multiple concurrent sequential read streams while maintaining SCR mode for each stream, enabling the WL to remain in a ramped-up state even when sequential reads are temporarily interrupted. In another approach, a memory sub-system controller (e.g., an ASIC controller) de-interleaves and reorders multi-stream sequential reads, coalescing commands into sequential blocks to maximize or improve the efficiency of the SCR operations. In yet another approach, a hybrid implementation combines the strengths of both approaches, where the memory sub-system controller identifies and tracks streams while communicating with the NAND firmware (e.g., the local media controllers on the memory device) through a specific protocol to control SCR mode activation/deactivation. This comprehensive solution improves read bandwidth, such as in array-limited cases, by maintaining WL voltage levels for sequential accesses across multiple streams, particularly benefiting AI workloads that involve large volumes of interleaved sequential reads.

In some cases, the multi-stream SCR system can maintain multiple WLs simultaneously in the ramped-up state across different memory blocks or planes. This simultaneous maintenance of multiple ramped-up WLs can improve memory sub-system performance for workloads with multiple interleaved sequential streams, such as AI model loading operations that access multiple model components in parallel.

In some examples, a system is provided that includes a memory device of a memory sub-system. The memory device has a SCR mode that, when enabled, maintains a WL in a ramped-up state for sequential read commands directed to that WL. A processing device coupled to the memory device can identify and track multiple concurrent sequential read streams from read commands directed to the memory device. The processing device determines whether at least one of the multiple concurrent sequential read streams satisfies an SCR mode condition based on analyzing read patterns of the read commands. The processing device can then control activation of the SCR mode in the memory device for the at least one of the multiple concurrent sequential read streams in response to determining whether the SCR mode condition is satisfied. The SCR mode maintains the WL voltage in the ramped-up state for sequential reads to LP, UP, and XP locations of the WL. The WL voltage ramps down after completing reads to all pages of the WL, when switching to a different WL, or in response to disabling the SCR mode.

In some cases, the processing device identifies and tracks multiple concurrent sequential read streams by maintaining a queue storing data associated with each stream including last n PBAs. An eviction policy tracks a limited number of most recent or most common streams. Criteria assign incoming PBAs to existing streams or identify new streams based on sequential patterns. The processing device determines SCR mode satisfaction by analyzing whether multiple read commands target a same WL in a group of SBs on a same memory die plane. The read commands may need to follow a sequential pattern within a defined threshold. For example, the processing device controls SCR mode activation by enabling it for a first command in a sequential read sequence. The SCR mode is maintained while sequential reads are temporarily interrupted by reads to other WLs. The SCR mode can be disabled after a threshold time without sequential reads or to protect data integrity.

The processing device can store sequential data in SCR-block chunks and coalesces host read commands into SCR-block sized chunks. The processing device separates interleaved sequential streams, reorders commands within each stream for sequential addressing, inserts supplemental read commands to maintain sequential patterns, and combines reordered commands into a coalesced sequence. The processing device sends commands to enable/disable SCR mode based on stream analysis. Status information indicates current SCR mode state. The memory device may override SCR enable commands to protect data integrity.

The processing device optimizes machine learning model loading traffic patterns by analyzing read patterns to identify sequential data that requires sequential reads. The device uses host hints to identify sequential data during initial writes and maintains sequential data layout during garbage collection operations. Additionally, the processing device (or host system) can defragment files to create sequential logical block address ranges, ensuring optimal sequential access patterns. In some examples, the processing device tracks timing of sequential read commands and monitors neighboring WL read activity. SCR mode can be disabled to protect data integrity when neighboring WLs are frequently accessed.

The processing device includes any one of or a combination of a memory sub-system controller, host system, and/or local media controller. The memory device includes a three-dimensional (3D) NAND device. Instructions stored on non-transitory machine-readable storage media execute the operations when run by the processing device. A method performs the operations of identifying and tracking streams, determining SCR mode satisfaction, and controlling SCR mode activation and/or deactivation.

Though various examples are described herein as being implemented with respect to a memory sub-system (e.g., a controller of the memory sub-system), some or all of the portions of an embodiment can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more nonvolatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of nonvolatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a PCIe interface, a compute express link (CXL) interface, a universal serial bus (USB) interface, a Fibre Channel interface, a Serial Attached SCSI (SAS) interface, and so forth. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of nonvolatile memory devices and/or volatile memory devices. The volatile memory devices can be, but are not limited to, random access memory (RAM), such as dynamic random access memory (DRAM) and synchronous dynamic random access memory (SDRAM). Some examples of nonvolatile memory devices (e.g., memory device 130) include a NAND flash memory and write-in-place memory, such as a 3D cross-point memory device, which is a cross-point array of nonvolatile memory cells. A cross-point array of nonvolatile memory can perform bit storage based on a change of bulk resistance, in conjunction with a stackable cross-gridded data access array. Additionally, in contrast to many flash-based memories, cross-point nonvolatile memory can perform a write in-place operation, where a nonvolatile memory cell can be programmed without the nonvolatile memory cell being previously erased. NAND type flash memory includes, for example, two-dimensional (2D) NAND and 3D NAND.

Each of the memory devices 130, 140 can include one or more arrays of memory cells. One type of memory cell, for example, single level cells (SLCs), can store one bit per cell. Other types of memory cells, such as multi-level cells (MLCs), tri-level cells (TLCs), quad-level cells (QLCs), and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or BSs. As used herein, a block comprising SLCs can be referred to as a SLC block, a block including MLCs can be referred to as a MLC block, a block comprising TLCs can be referred to as a TLC block, and a block including QLCs can be referred to as a QLC block.

Although nonvolatile memory components such as NAND-type flash memory (e.g., 2D NAND, 3D NAND) and 3D cross-point array of nonvolatile memory cells are described, the memory device 130 can be based on any other type of nonvolatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data (e.g., performing GC operations) at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 (or multiple processors) configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115 and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, debugging operations, error detection and ECC operations, encryption operations, caching operations, and address translations between a logical address (e.g., LBA, namespace) and a physical memory address (e.g., physical block address in a physical address space of the memory device 130 or memory device 140) that are associated with the memory devices 130, 140. The memory sub-system controller 115 can further include host interface circuitry to communicate with the host system 120 via the physical host interface (e.g., a PCIe link). The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (MNAND) device. Any operation discussed as being performed by the memory sub-system controller 115 can be similarly performed by the local media controllers 135 and vice versa alternatively or additionally.

The SCR control system 142 can be implemented by any one or combination of the local media controllers 135, memory sub-system controller 115, and/or host system 120.

In some examples, when implemented as part of the local media controllers 135, the SCR control system 142 identifies and tracks multiple concurrent sequential read streams by maintaining a queue that stores data associated with each stream, including the last n physical block addresses. The SCR control system 142 can implement an eviction policy to track a limited number (e.g., threshold number) of most recent streams and applies criteria to assign incoming physical block addresses (PBAs) to existing streams or identify new streams based on sequential patterns.

The SCR control system 142 can, not only identify and track multiple concurrent sequential read streams, but can also simultaneously maintain multiple WLs in the ramped-up state when these streams target different WLs. For example, when the SCR control system 142 detects a first sequential stream accessing WL1 and a second sequential stream accessing WL5, it can activate SCR mode for both WLs simultaneously rather than forcing one stream to wait for the other to complete. This capability enables true parallel processing of multiple sequential streams, which is particularly valuable for memory-intensive applications that access multiple data structures concurrently.

For each stream, the SCR control system 142 analyzes whether multiple read commands target the same WL in a group of SBs on the same memory die plane. The SCR control system 142 can determine if the read commands follow a sequential pattern within a defined threshold, tolerating skips and out-of-sequence commands within acceptable ranges.

For example, the SCR control system 142 analyzes read patterns and applies thresholds in various ways. When examining sequential patterns, the SCR control system 142 can receive PBAs [0, 1, 2, 100, 3, 4, 5] all targeting the same WL1. The SCR control system 142 recognizes this as a valid sequential pattern despite the interruption by PBA 100, since the majority of reads (PBAs 0-5) maintain sequential ordering. With thresholds configured to permit 1-2 non-sequential reads within an 8-read sequence, this pattern can qualify for SCR mode activation. In response to recognizing this sequential pattern, including a threshold number of interruptions involving non-sequential reads to the same WL or different WL interleaved with sequential reads to the same WL, the SCR control system 142 activates the SCR mode (e.g., temporarily) to maintain the WL in a ramped-up state through all reads, including the non-sequential PBA 100, improving overall read efficiency.

In contrast, the SCR control system 142 can receive another stream including reads to PBAs [4, 1, 6, 2, 8, 3] targeting the same WL. Although these reads target the same WL, the SCR control system 142 determines this pattern is too random to qualify for SCR mode. The SCR control system 142 can employ a threshold requiring, for example, at least 60%, of reads to follow sequential ordering and can determine that this pattern fails to meet that threshold.

Consequently, these reads are treated as random accesses without SCR-mode optimization. In such cases, the SCR control system 142 does not activate the SCR mode.

The SCR control system 142 dynamically adjusts its thresholds based on several key factors. The SCR control system 142 analyzes the most recent physical block addresses to detect sequential patterns, such as examining the last 8-10 PBAs. When analyzing these patterns, the SCR control system 142 can require that 60-80% (or some other threshold percentage) of the reads follow a sequential order and allows gaps of 2-3 PBA numbers while still maintaining sequential status. The SCR control system 142 can enforce a time window of 100-200 microseconds for pattern detection. The SCR control system 142 can continuously adjust these thresholds by evaluating several factors. First, the SCR control system 142 can consider the current frequency of sequential read commands, where higher frequencies may lower the sequential percentage threshold since patterns are more likely to be genuine. Second, the SCR control system 142 can weigh potential power and performance benefits from enabling SCR mode, where greater potential savings may justify more lenient thresholds. Third, the SCR control system 142 can assess the risk of data corruption from neighboring WL activity, where higher risks lead to stricter thresholds and shorter time windows.

For example, the SCR control system 142 dynamically adjusts its thresholds based on several key factors that affect read performance and data integrity. For example, during AI model loading operations where multiple sequential streams are common, the SCR control system 142 may lower the sequential percentage threshold from 80% to 60% to better accommodate the workload patterns. Second, the SCR control system 142 can calculate potential performance benefits. Namely, when reading multiple pages from the same WL can achieve a 10-20% improvement in read bandwidth for array-limited cases, the SCR control system 142 can apply more lenient pattern matching criteria. Third, the SCR control system 142 can assess data integrity risks by monitoring neighboring WL activity. Specifically, if adjacent WLs are accessed more frequently than once per 100-200 microseconds, the SCR control system 142 can implement stricter thresholds or reduce the maximum time a WL can remain in ramped-up state from 200 to 100 microseconds to prevent potential data corruption.

The SCR control system 142 can selectively, dynamically, and/or intelligently enable the SCR mode for the memory device 130, such as for a first command in a sequential read sequence, and can maintain the WL in a ramped-up state even when sequential reads are temporarily interrupted by reads to other WLs. The SCR control system 142 monitors timing of sequential read commands and neighboring WL activity, disabling SCR mode if neighboring WLs are frequently accessed to protect data integrity.

For example, when sequential reads are detected to WL1, the SCR control system 142 can enable SCR mode and maintains the WL1 voltage in a ramped-up state. This allows efficient reading of multiple pages from that WL without redundant initialization and recovery operations. However, if no additional sequential read commands arrive for WL1 within a specified window of time, such as a 200 microsecond window, the SCR control system 142 determines the sequential pattern has ended. The SCR control system 142, in response, can then disables SCR mode and ramps down the WL1 voltage to conserve power, since maintaining the ramped-up state is no longer beneficial.

When maintaining multiple WLs simultaneously in the ramped-up state, the SCR control system 142 can implement resource management to balance performance benefits against power consumption and potential data integrity risks. The SCR control system 142 can apply different timeout thresholds for different WLs based on their access patterns and can prioritize certain WLs for continued SCR mode operation based on stream characteristics. For example, if WL1 and WL2 are both in SCR mode but SCR control system 142 resources become constrained, the SCR control system 142 may maintain SCR mode for the WL with more frequent sequential accesses while selectively disabling SCR mode for the less active WL. This dynamic resource allocation ensures optimal system performance even when supporting multiple concurrent SCR operations across different WLs.

In cases where data integrity is at risk, the SCR control system 142 takes protective action regardless of ongoing sequential reads. For example, while sequential reads are occurring to WL1 with SCR mode enabled, the SCR control system 142 monitors access patterns to adjacent WLs, such as WL0 and WL2. If these neighboring WLs are accessed more frequently than once per some threshold time period, such as 100 microseconds, the sustained voltage stress could potentially corrupt data. The SCR control system 142 responds by immediately disabling SCR mode and ramping down the WL1 voltage, even though sequential reads to WL1 are still arriving. This demonstrates how the SCR control system 142 prioritizes data protection over performance optimization when access patterns indicate increased corruption risk.

In some cases, the SCR control system 142 can be implemented as part of the memory sub-system controller 115. In such cases, the SCR control system 142 can operate differently. Namely, the SCR control system 142 can store sequential data in SCR-block chunks based on block size for memory type. Namely, for SLC blocks, the SCR-block size can be 48 KB across multiple SBs, while for TLC blocks the SCR-block size can be 144 KB.

For example, for SLC blocks, the SCR control system 142 can store sequential data, received from the host system 120, in 48 KB chunks calculated as: 4 KB per page×4 pages per WL×1 WL per SB×3 SBs. Namely, when writing a 144 KB sequential data stream, the SCR control system 142 can organize the data into three 48 KB SCR-block chunks aligned to SB boundaries.

Specifically, when the host system 120 sends sequential data to the memory sub-system 110, the SCR control system 142 processes and organizes this data based on memory type. For SLC blocks, the SCR control system 142 maintains this organization by using host hints to identify which incoming data will require sequential reads. During the initial write operation, the SCR control system 142 stores this identified sequential data contiguously within appropriate SCR-block chunks without interruption by random writes. The SCR control system 142 preserves this sequential layout during subsequent GC operations to ensure the data remains optimally organized for future SCR operations. For example, if the host system 120 sends a sequential stream of LBAs [0, 1, 2, 3, 4, 5, 6, 7, 8], the SCR control system 142 can store these contiguously within 48 KB SCR-block chunks. This organization allows the SCR control system 142 to later perform efficient sequential reads by maintaining the WL in a ramped-up state across multiple sequential read operations to those addresses.

As another example, if the host system 120 sends an initial sequence of LBAs [0, 1, 10, 3, 11, 12, (100), 15, 14, 13, 4, 7, 6, (200), 16, 17, 18], the SCR control system 142 identifies this as containing both sequential streams and random writes. The SCR control system 142 separates this into sequential streams and moves the random writes (100) and (200) to a different part of the sequence.

For TLC blocks, the SCR control system 142 handles larger 144 KB chunks calculated as: 4 KB per page×4 pages per WL×3 WL per SB×3 SBs. For instance, when processing a 432 KB sequential data stream, the SCR control system 142 can divide the data into three 144 KB SCR-block chunks.

The SCR control system 142 maintains this data organization during write operations. For example, the SCR control system 142 can store sequential data without interruption by random writes, preserve sequential alignment during GC operations, and use timestamps during initial writes to identify continuous sequential data streams. For example, if the SCR control system 142 detects that LBAs 0-100 represent a continuous sequential stream during initial write, the SCR control system 142 ensures these are stored contiguously within appropriate SCR-block chunks, such as either 48 KB chunks for SLC or 144 KB chunks for TLC.

The SCR control system 142 uses timestamps during initial writes to identify and track continuous sequential data streams. Namely, during initial host write operations, the SCR control system 142 can apply timestamps to mark when sequential data blocks are written. For example, when writing a large AI model file, the SCR control system 142 adds timestamps to each write operation to establish temporal relationships between data blocks. This allows the SCR control system 142 to identify data that was written as part of the same continuous stream, even if interrupted by other operations. The timestamps can then be used during GC to identify and gather scattered sequential data. For instance, if timestamps show that LBAs 0-50 were written within a 100-microsecond window as part of model loading, while LBAs 51-100 were written 5 minutes later during a different operation, the SCR control system 142 can identify LBAs 0-50 as a continuous sequential stream that should be kept together.

In some cases, the SCR control system 142 can use host hints to identify data likely to be read sequentially during initial writes. It maintains sequential data layout during garbage collection operations and can defragment files to create sequential logical block address ranges.

When performing GC, the SCR control system 142 uses these timestamp relationships to scatter-gather large sequential read data that was identified as continuous based on timestamps, reorder the gathered data to align with SCR block boundaries, and/or maintain sequential alignment during folding operations to preserve the temporal locality identified by the timestamps. This timestamp-based tracking ensures that data written sequentially during initial operations remains optimally organized for future SCR operations, even after multiple garbage collection cycles.

In some examples, the SCR control system 142 can coalesce host read commands by separating interleaved sequential streams, reordering commands within each stream to create sequential address sequences, inserting supplemental read commands to maintain sequential patterns, and combining the reordered commands into a coalesced sequence.

For example, when the host system 120 sends an initial sequence of LBAs [0, 1, 10, 3, 11, 12, (100), 15, 14, 13, 4, 7, 6, (200), 16, 17, 18], the SCR control system 142 processes these commands in several ways. First, the SCR control system 142 separates the interleaved sequential streams by identifying that LBAs 0-8 form one sequential stream, LBAs 10-15 form another stream, and LBAs (100) and (200) are random reads. For each stream, the SCR control system 142 analyzes whether the commands target the same WL in a group of SBs on the same die plane. Next, the SCR control system 142 reorders the commands within each stream to create sequential address sequences. For example, LBAs [14, 13, 4, 7, 6] are reordered into [4, 6, 7, 13, 14] to maintain sequential ordering. The SCR control system 142 then inserts supplemental dummy read commands to fill any gaps in the sequence, for instance, adding dummy reads for LBAs 2, 5, and 8 to maintain sequential patterns. These are dummy reads because the host system 120 did not issue any commands to read those LBAs and they are simply inserted to keep the LBAs in a sequential order. This helps the memory device 130 recognize the read commands as being part of a sequential read pattern and automatically enable the SCR mode of the memory device 130 for that sequence until the sequence ends.

The SCR control system 142 can combine the reordered streams into a coalesced sequence: [0, 1, 2, 3, 4, 5, 6, 7, 8, (100), (200), 10, 11, 12, 13, 14, 15, 16, 17, 18]. This organization allows the SCR control system 142 to maintain the WL in a ramped-up state across multiple sequential read operations while handling the random reads (100) and (200) separately to minimize disruption of the sequential access patterns. In some cases, the SCR control system 142 instructs the memory device 130 to enable the SCR mode for a period of time and/or for the next sequence of reads. In some cases, the memory device 130 automatically enables the SCR mode in response to detecting more than two sequential read commands associated with the same WL.

In the hybrid implementation combining both approaches, the memory sub-system controller 115 identifies and tracks multiple sequential read streams as in the ASIC-only implementation. The memory sub-system controller 115 determines when to start SCR mode based on analyzing traffic patterns. The memory sub-system controller 115 sends explicit commands to the local media controllers 135 to enable or disable SCR mode using a particular protocol. Status information indicates the current SCR mode state.

The local media controllers 135 maintain SCR mode operation but can override SCR enable commands from the memory sub-system controller 115 to protect data integrity. This creates a collaborative relationship where memory sub-system controller 115 handles stream detection while the NAND firmware manages the actual SCR mode operation.

The hybrid approach leverages the controller's broader view of multiple streams while utilizing the NAND firmware's direct control over WL voltage management. This provides optimal handling of interleaved sequential streams while maintaining data integrity protections.

Any discussion with respect to the memory device 130 can similarly be applied to the memory device 140. Any function pertaining to the local media controllers 135 can, in some cases, be performed by the memory sub-system controller 115.

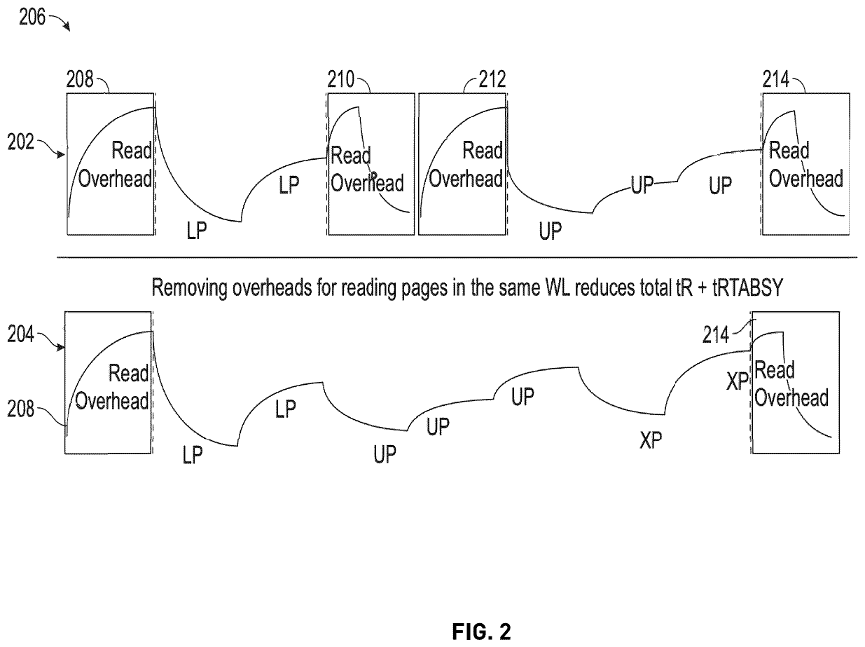

FIG. 2 illustrates SCR mode diagrams 206, in accordance with some examples. Specifically, FIG. 2 illustrates SCR mode diagrams 206 that demonstrate how removing read overheads when the SCR mode of the memory device 130 is enabled or activated reduces total read time and recovery time relative to performing the same read commands when the SCR mode of the memory device 130 is disabled or deactivated. The SCR mode diagrams 206 show two scenarios including a disabled SCR mode 202 and an enabled SCR mode 204 both for the memory device 130.

In disabled SCR mode 202, the SCR control system 142 performs multiple read overhead operations between page and/or WL reads. The first read overhead 208 precedes a LP read, followed by second read overhead 210 before an UP read. The third read overhead 212 and fourth read overhead 214 are required for subsequent UP and LP reads.

For example, in the disabled SCR mode 202 (e.g., when the SCR mode of the memory device 130 is in the disabled state), the SCR control system 142 performs a complete sequence of read overhead operations between each page and/or WL read. Specifically, the first read overhead 208 includes initializing the WL with a prologue and ramping up the WL voltage (~VpassR ramp). After this first read overhead 208 completes, the SCR control system 142 performs a LP read. The WL voltage is then ramped down during recovery. The second read overhead 210 is encountered by repeating the entire initialization sequence, such as ramping up the WL voltage again from its ramped-down state before performing the UP read. This is followed by another recovery phase ramping down the voltage. The pattern continues with a third read overhead 212 and a fourth read overhead 214, each involving full initialization and recovery sequences between subsequent UP and LP reads. The WL voltage may completely be ramped-up and down between every read operation.

This sequence demonstrates why the disabled SCR mode is inefficient as the same WL may repeatedly undergo voltage ramping between reads, even though the reads are accessing the same WL. The system wastes both time and power by ramping down the WL voltage after each read, re-initializing and ramping up the voltage for the next read, and performing recovery operations between every read operation This contrasts with the enabled SCR mode 204 (e.g., when the SCR mode of the memory device 130 is in the enabled state), which maintains the ramped-up WL voltage state across multiple sequential reads to the same WL, eliminating the overhead of repeated voltage ramping. Namely, in the enabled SCR mode 204, the SCR control system 142 maintains the WL in a ramped-up state during sequential reads. Only a single initial read overhead (e.g., the first read overhead 208) is needed before the LP read, allowing seamless reading of UP and XP data without intermediate overheads. A final read overhead (e.g., the fourth read overhead 214) occurs after completing all page reads from the WL. By maintaining the WL voltage in a ramped-up state rather than repeatedly ramping up and down, the SCR control system 142 reduces overall read time and power consumption.

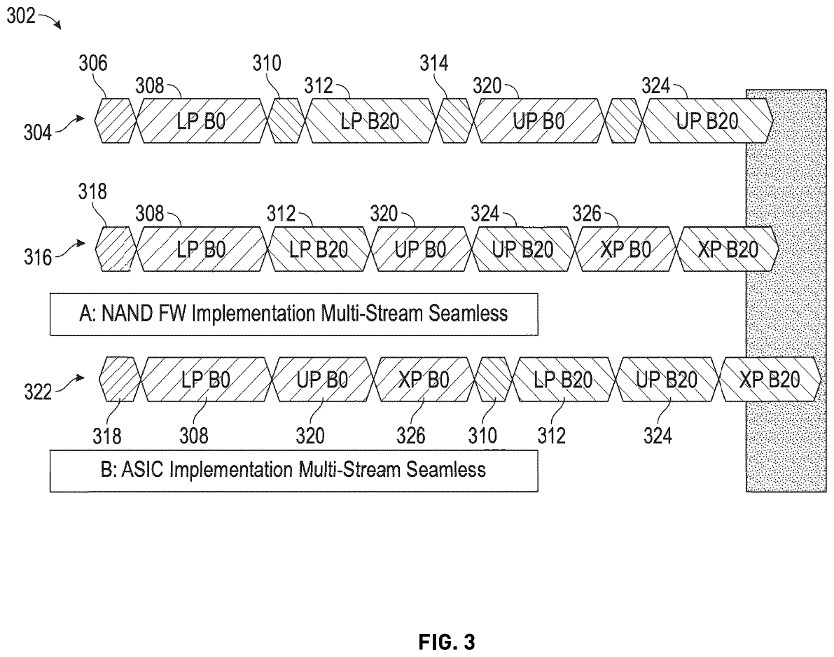

FIG. 3 is a diagram 302 of operations performed by the SCR control system 142, in accordance with some examples. Specifically, the diagram 302 shows two different implementations of enabling the SCR mode for multi-stream SCR operations and how read commands to the same PBAs are processed when the SCR mode is maintained in the disabled state throughout.

Specifically, the first read sequence with SCR mode disabled 304 demonstrates how the read commands are processed while ramping up and down the voltage to the WL between such commands. For example, a first read overhead 306 is performed, followed by a LP read to block 0 (LP B0; e.g., a first portion of data 308). After the first portion of data 308 is read, the second read overhead 310 is encountered to ramp down and then back up the voltage on the WL before the second portion of data 312 (e.g., LP block 20) is read. After the second portion of data 312 is read, a third read overhead 314 is encountered to ramp down and then back up the voltage on the WL before the third portion of data 320 (e.g., the UP block 0) is read. This sequence continues to read the fourth portion of data 324. This inefficient sequence demonstrates why conventional systems waste power and time by repeatedly ramping WL voltages, even when reading sequential pages from the same WL. The overhead operations between each read operation (e.g., the second read overhead 310 and the third read overhead 314) include initialization with prologue and voltage ramp up, followed by recovery procedures to ramp down the voltage.

The first read sequence with SCR mode disabled 304 demonstrates how read commands are processed while repeatedly ramping up and down the WL voltage between sequential reads. For example, when reading LP BO and UP BO, which are sequential pages in block 0, the SCR control system 142 performs unnecessary overhead operations between the reads. After reading LP B0, the SCR control system 142 ramps down the WL voltage during second read overhead 310, only to immediately ramp it back up to read UP B0. This inefficient process continues between UP B0 and subsequent reads, requiring third read overhead 314 to again ramp down and back up the WL voltage. The SCR control system 142 wastes both time and power by repeatedly performing these voltage transitions even though it is accessing sequential pages (LP and UP) from the same block.

The second read sequence with SCR mode enabled 316 addresses this inefficiency by maintaining the WL in a ramped-up state across sequential reads to the same block. Rather than ramping down after LP B0 and ramping up again for UP B0, the SCR control system 142 keeps the WL voltage elevated to enable seamless reading of the sequential pages. This eliminates the redundant overhead operations between reads to sequential pages in the same block, improving read performance by 10-20% in array-limited cases. This is demonstrated by the operations shown for the second read sequence with SCR mode enabled 316 and the third read sequence with SCR mode enabled 322.

The second read sequence with SCR mode enabled 316 and the third read sequence with SCR mode enabled 322 represent alternate approaches to reading the same blocks discussed in relation to the first read sequence with SCR mode disabled 304. Namely, the second read sequence with SCR mode enabled 316 can involve an implementation of the SCR control system 142 on the memory device 130. Specifically, the second read sequence with SCR mode enabled 316 and the third read sequence with SCR mode enabled 322 demonstrate how the memory device 130 optimizes read operations by maintaining the WL in a ramped-up state even when sequential reads are temporarily interrupted (e.g., in response to detecting that sequential read streams satisfy an SCR mode condition) after the first read overhead 318. When the SCR control system 142 identifies sequential reads to the same WL, such as LP B0 followed by UP B0, it enables SCR mode and maintains the WL voltage rather than performing the overhead operations (e.g., the second read overhead 310 and third read overhead 314) between reads.

The SCR mode condition refers to criteria that determine when to enable and maintain SCR mode for sequential read operations. Specifically, the condition is satisfied when multiple read commands target the same WL in a group of SBs on the same die plane and follow a sequential pattern within defined thresholds. The SCR control system 142 analyzes whether reads maintain sequential ordering within acceptable gap ranges, evaluates potential time and energy savings from enabling SCR mode, and considers the frequency of current sequential read commands to determine if the condition is met. The condition also accounts for data integrity risks by monitoring neighboring WL activity and access patterns that could impact the safety of maintaining the WL in a ramped-up state.

For example, if a random read interrupts the sequential pattern between LP BO and UP BO, conventional systems would ramp down the WL voltage during the second read overhead 310 and ramp it back up during the third read overhead 314. However, with SCR mode enabled, the SCR control system 142 recognizes that LP B0 and UP B0 are part of a sequential stream and maintains the WL in a ramped-up state through the interruption of reading the second portion of data 312 between the first portion of data 308 and the third portion of data 320. The WL is maintained in the ramped-up state while reading the fourth portion of data 324 and the fifth portion of data 326. This eliminates the need for redundant voltage ramping operations between the sequential reads, even though they are separated by a non-sequential access.

The SCR control system 142 achieves this by tracking multiple concurrent sequential streams and maintaining SCR mode for each stream independently. When it detects that reads are targeting the same WL in a group of SBs on the same die plane, it keeps the WL voltage elevated to enable seamless reading of sequential pages, improving read performance.

The SCR control system 142 can deactivate SCR mode in some cases. For example, when sequential reads to a WL have stopped for a threshold time period (e.g., 200 microseconds), the SCR control system 142 disables SCR mode and ramps down the WL voltage to conserve power. This occurs because maintaining the WL in a ramped-up state consumes energy, so if no additional sequential reads are arriving within the timeout window, the SCR control system 142 determines the sequential pattern has ended. The SCR control system 142 also disables SCR mode immediately if it detects a data integrity risk, even if sequential reads are still occurring. For example, if neighboring WLs are being accessed more frequently than once per 100-200 microseconds, the sustained voltage stress from maintaining the ramped-up state could potentially corrupt data. In this case, the SCR control system 142 prioritizes data protection by disabling SCR mode and ramping down the WL voltage despite ongoing sequential access patterns.

The SCR control system 142 may also disable SCR mode when sequential reads are interrupted by reads to other WLs in different blocks or SBs, the frequency of neighboring WL accesses exceeds thresholds that could risk data integrity, and/or the NAND firmware overrides SCR enable commands to protect data integrity.

In some examples, the third read sequence with SCR mode enabled 322 demonstrates how the memory device 130 implements SCR mode through the NAND firmware approach, such as when the SCR control system 142 is implemented on the memory sub-system controller 115. In such cases, when the SCR control system 142 identifies sequential reads to the same WL, such as LP B0 followed by UP B0 and XP B0, the SCR control system 142 enables SCR mode and maintains the WL voltage rather than performing redundant overhead operations between reads.

Specifically, in the third read sequence with SCR mode enabled 322, the memory sub-system controller 115 reorders read commands before sending them to the memory device 130. When the SCR control system 142 identifies sequential reads to the same WL, such as LP B0 followed by UP B0 and XP B0, the SCR control system 142 reorders these commands to create a purely sequential stream without interruptions. The memory sub-system controller 115 then sends these reordered commands to the memory device 130, which can automatically enable SCR mode or enable the SCR mode in response to an explicit command from the memory sub-system controller 115. This contrasts with the second read sequence with SCR mode enabled 316, where the read commands remain in their original interleaved or interrupted order. In the second read sequence with SCR mode enabled 316, the memory device 130 handles interrupted sequential patterns and decides to maintain the WL in a ramped-up state even when sequential reads are temporarily interrupted by other reads.

The key difference is that in implementing the third read sequence with SCR mode enabled 322, the memory sub-system controller 115 performs the work of organizing commands into clean sequential streams before sending them to the memory device 130. For example, if the original sequence contains interleaved reads, like [LP B0, LP B20, UP B0, UP B20], the memory sub-system controller 115 reorders them into [LP B0, UP B0, XP B0, LP B20, UP B20], allowing the memory device 130 to process them as pure sequential streams.

This reordering eliminates the need for the memory device 130 to handle interrupted sequential patterns, simplifying its SCR mode operation.

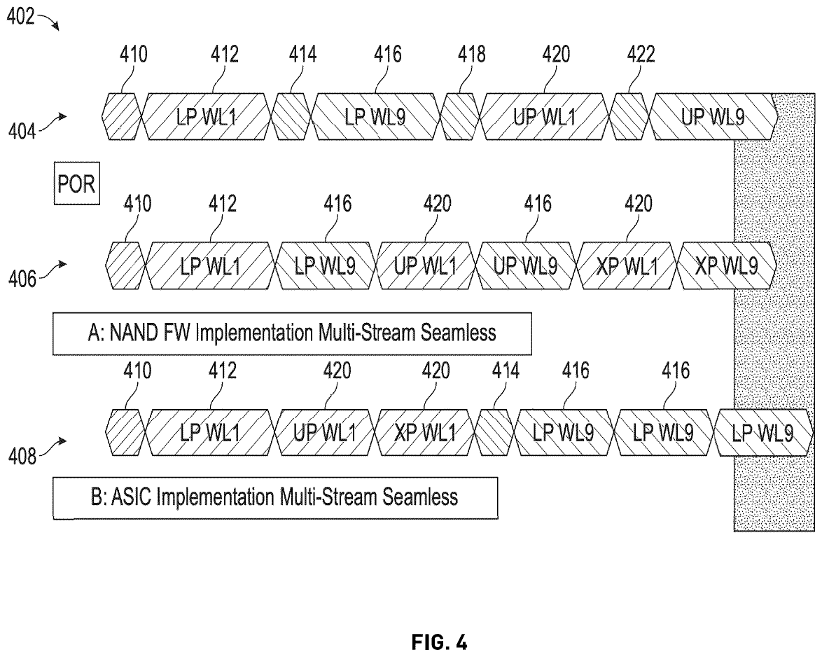

FIG. 4 is a diagram 402 of operations performed by the SCR control system 142, in accordance with some examples. The diagram 402 demonstrates how read commands are processed with and without SCR mode enabled when accessing multiple WLs.

The first read sequence with SCR mode disabled 404 shows how read commands are processed while repeatedly ramping up and down the WL voltage between reads. A first read overhead 410 is performed, followed by a LP read to WL1 (LP WL1; e.g., a first portion of data 412). After reading LP WL1, a second read overhead 414 ramps down and back up the WL voltage before reading LP WL9 (e.g., the second portion of data 416). After the second portion of data 416 is read, a third read overhead 418 ramps down and up the voltage again before reading UP WL1 (e.g., a third portion of data 420). This inefficient sequence continues through subsequent reads, requiring fourth read overhead 422 between operations.

The second read sequence with SCR mode enabled 406 demonstrates how the memory device 130 optimizes read operations by maintaining the WL in a ramped-up state even when sequential reads are temporarily interrupted. When the SCR control system 142 identifies sequential reads to the same WL, such as LP WL1 (e.g., the first portion of data 412) followed by UP WL1 (e.g., the third portion of data 420), the SCR control system 142 enables SCR mode and maintains the WL voltage rather than performing redundant overhead operations between reads.

For example, if a random read interrupts the sequential pattern between the first portion of data 412 and the third portion of data 420, conventional systems would ramp down the WL voltage during the second read overhead 414 and ramp it back up during the third read overhead 418. However, with SCR mode enabled, the SCR control system 142 recognizes that LP WL1 and UP WL1 are part of a sequential stream and maintains the WL in a ramped-up state through any interruptions.

The SCR control system 142 achieves this by tracking multiple concurrent sequential streams and maintaining SCR mode for each stream independently. When the SCR control system 142 detects that reads are targeting the same WL in a group of SBs on the same die plane, the SCR control system 142 keeps the WL voltage elevated to enable seamless reading of sequential pages.

The SCR control system 142 can be designed to optimize performance across multiple dimensions by simultaneously maintaining multiple WLs in the ramped-up state. This capability provides advantages for complex workloads that involve concurrent access to multiple sequential data streams, such as when an AI application loads different parts of a machine learning model simultaneously. By enabling SCR mode on multiple WLs concurrently, the SCR control system 142 reduces the total overhead operations by 40-60% compared to conventional systems that can only maintain a single WL in SCR mode at a time. The SCR control system 142 monitors the power consumption associated with maintaining multiple ramped-up WLs and implements intelligent throttling when necessary to stay within power budget constraints while maximizing performance benefits.

The SCR control system 142 deactivates SCR mode when sequential reads to a WL have stopped for a threshold time period (e.g., 200 microseconds). This occurs because maintaining the WL in a ramped-up state consumes energy, so if no additional sequential reads arrive within the timeout window, the SCR control system 142 determines the sequential pattern has ended. The SCR control system 142 also disables SCR mode immediately if it detects a data integrity risk, even if sequential reads are still occurring. For example, if neighboring WLs are being accessed more frequently than once per 100-200 microseconds, the sustained voltage stress could potentially corrupt data.

The third read sequence with SCR mode enabled 408 shows how the memory sub-system controller 115 reorders read commands before sending them to the memory device 130. When the SCR control system 142 identifies sequential reads to the same WL, such as LP WL1 followed by UP WL1 and XP WL1, the SCR control system 142 reorders these commands to create a purely sequential stream without interruptions. The memory device 130 can then automatically enable SCR mode or enable it in response to an explicit command from the controller.

This contrasts with the second read sequence with SCR mode enabled 406, where the read commands remain in their original interleaved order. The key difference is that in implementing the third read sequence with SCR mode enabled 408, the memory sub-system controller 115 performs the work of organizing commands into clean sequential streams. For example, if the original sequence contains interleaved reads like [LP WL1, LP WL9, UP WL1, UP WL9], the memory sub-system controller 115 reorders them into [LP WL1, UP WL1, XP WL1, LP WL9, UP WL9], allowing the memory device 130 to process them as pure sequential streams.

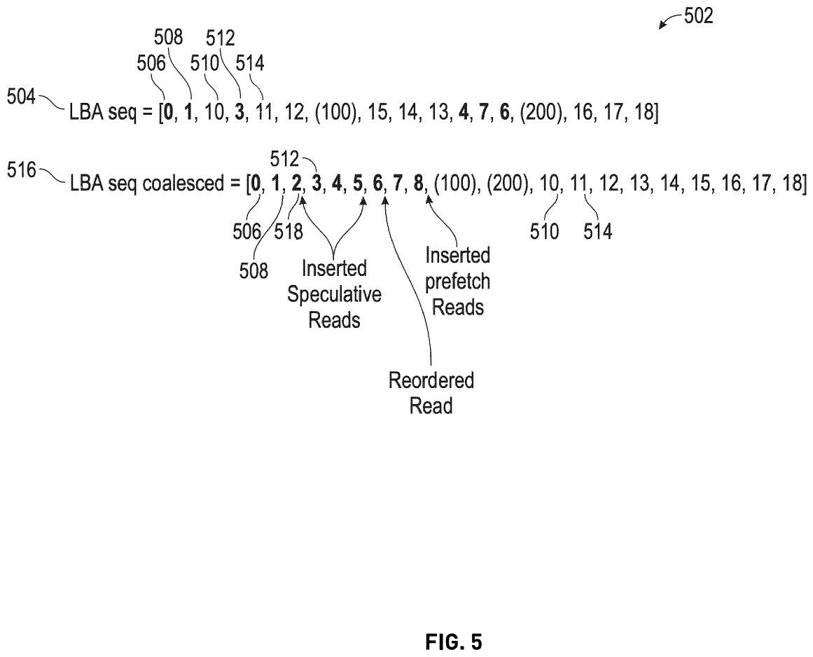

FIG. 5 is a diagram 502 of operations performed by the SCR control system 142, in accordance with some examples. The diagram 502 shows an initial sequence of logical block addresses (LBAs; e.g., first sequence of read commands 504) that contains both sequential streams and random reads.

When the host system 120 sendse first sequence of read commands 504 containing LBAs [0, 1, 10, 3, 11, 12, (100), 15, 14, 13, 4, 7, 6, (200), 16, 17, 18], the SCR control system 142 (e.g., implemented as part of the memory sub-system controller 115) begins its optimization process. The numbers in parentheses (100) and (200) represent random reads that interrupt the otherwise sequential streams. The first sequence of read commands 504 can include the first LBA 506, second LBA 508, third LBA 510, fourth LBA 512, fifth LBA 514, and so forth. The third LBA 510 can be a random read or read associated with a second sequential stream that is placed between sequential reads of a first sequential stream that includes the first LBA 506, second LBA 508, and fourth LBA 512.

The SCR control system 142 first analyzes the first sequence of read commands 504 to identify potential sequential patterns and interruptions. The SCR control system 142 examines the read commands to determine if they target the same WL in a group of SBs on the same die plane. Upon detecting multiple sequential streams, the SCR control system 142 begins inserting speculative reads (e.g., a dummy LBA 518) to maintain sequential patterns. These speculative reads or dummy LBAs fill gaps in the sequence to ensure continuous sequential access. The SCR control system 142 then determines where to insert prefetch reads to optimize performance. These prefetch operations help maintain efficient read patterns by anticipating upcoming sequential reads.

Specifically, the SCR control system 142 identifies gaps in the sequence, and, in response, the SCR control system 142 adds dummy reads as speculative reads. For example, it adds reads for LBAs 2, 5, and 8 to maintain sequential patterns between existing reads to generate the second sequence of read commands 516 (e.g., a coalesced sequence of read commands).

Through reordered read operations, the SCR control system 142 reorganizes the commands to group sequential reads together. This creates longer continuous sequences that can benefit from maintaining the WL in a ramped-up state. The SCR control system 142 moves random reads (100) and (200) to positions between the sequential streams to minimize their impact on sequential access patterns. This allows the sequential streams to maintain optimal performance. For example, the final result shown in the second sequence of read commands 516 is a coalesced sequence: [0, 1, 2, 3, 4, 5, 6, 7, 8, (100), (200), 10, 11, 12, 13, 14, 15, 16, 17, 18]. This optimized sequence allows the memory device 130 to process reads more efficiently. Namely, the second sequence of read commands 516 has the first LBA 506, second LBA 508 and fourth LBA 512 which were separated in the first sequence of read commands 504 by the third LBA 510 (a non-sequential part of the sequence) now sequentially organized by having an additional dummy LBA 518 to one of the LBAs that is part of the sequence and which was not issued as a read from the host system 120. The second sequence of read commands 516 has moved the third LBA 510 and fifth LBA 514, which relate to another sequence of read commands, to follow the random reads (100 and 200).

Through reordered read operationse SCR control system 142 processes an initial sequence from the host system 120 to optimize a sequential read performance. When receiving the initial sequence [0, 1, 10, 3, 11, 12, (100), 15, 14, 13, 4, 7, 6, (200), 16, 17, 18], the SCR control system 142 analyzes the commands to identify sequential streams and random reads.

The SCR control system 142 first separates the sequence into distinct sequential streams, such as one containing LBAs 0-8 and another containing LBAs 10-15. For gaps in these sequences, such as missing LBAs 2, 5, and 8, the SCR control system 142 adds speculative reads to maintain sequential patterns. The SCR control system 142 also identifies random reads (100) and (200) that interrupt the sequential streams.

Next, the SCR control system 142 reorders the out-of-sequence reads (14, 13, 4, 7, 6) into proper sequential order and positions the random reads (100) and (200) between the sequential streams. This creates a coalesced sequence: [0, 1, 2, 3, 4, 5, 6, 7, 8, (100), (200), 10,11, 12, 13, 14, 15, 16, 17, 18]. The reordering enables the memory device 130 to process reads more efficiently by maintaining WL voltage levels across longer sequences of sequential reads. This optimization improves read performance in several ways. First, it creates pure sequential streams that can utilize SCR mode effectively. Second, it minimizes disruption from random reads by positioning them strategically between sequential streams. Third, it enables the SCR control system 142 to maintain WL voltage levels across extended sequential read operations, improving read bandwidth. The reordering transforms what began as interleaved and interrupted patterns into optimized sequences that maximize the benefits of maintaining WLs in a ramped-up state during sequential read operations. This is particularly beneficial for AI workloads that involve large volumes of interleaved sequential reads during model loading.

The reordering enables the memory device 130 to maintain WL voltage levels across multiple sequential reads. By processing the reads as pure sequential streams, the SCR control system 142 can maximize the benefits of SCR mode operation.

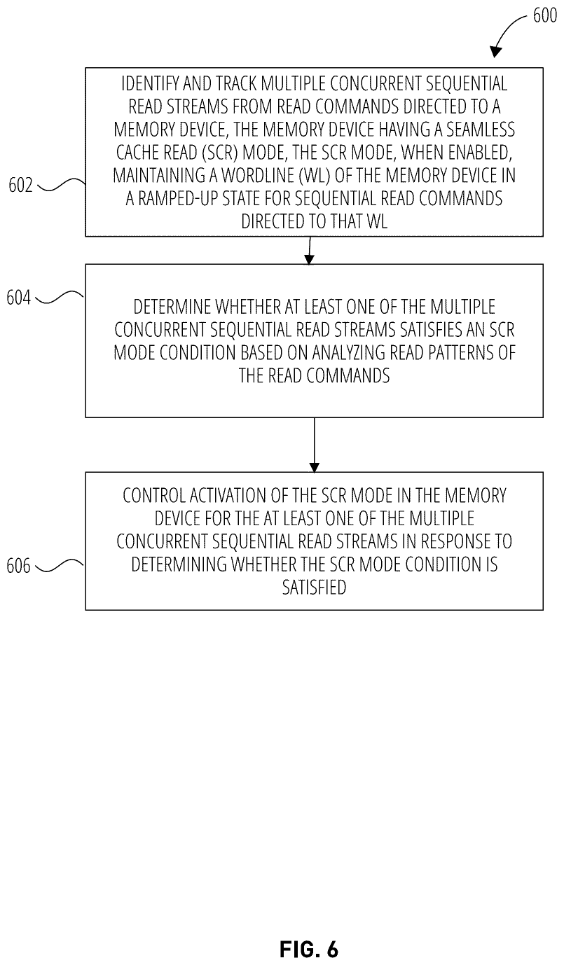

FIG. 6 illustrates a flowchart 600 of operations performed using the SCR control system 142, in accordance with some examples. The method or process of flowchart 600 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method or process of flowchart 600 is performed by the memory sub-system controller 115, local media controllers 135, and/or subcomponents of the memory sub-system controller 115 and/or local media controllers 135 of FIG. 1. In these examples, the method or process of flowchart 600 can be performed, at least in part, by the SCR control system 142. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example, other process flows are possible.

Referring now to FIG. 6, the method begins at operation 602 where the SCR control system 142 identifies and tracks multiple concurrent sequential read streams from read commands directed to the memory device 130. The SCR control system 142 maintains a queue storing data associated with each stream including the last n physical block addresses (PBAs) and implements an eviction policy to track a limited number of most recent or most common streams. The SCR control system 142 applies criteria to assign incoming PBAs to existing streams or identify new streams based on sequential patterns.

In operation 604, the SCR control system 142 determines whether at least one of the multiple concurrent sequential read streams satisfies an SCR mode condition. The SCR control system 142 analyzes whether multiple read commands target the same WL in a group of SBs on the same die plane and follow sequential patterns within defined thresholds. The SCR control system 142 evaluates potential time and energy savings from enabling SCR mode and considers the frequency of current sequential read commands to determine if the condition is met.

In operation 606, the SCR control system 142 controls activation of the SCR mode in the memory device 130. When sequential reads to a WL have stopped for a threshold time period (e.g., 200 microseconds), the SCR control system 142 disables SCR mode and ramps down the WL voltage to conserve power. The SCR control system 142 also disables SCR mode immediately if it detects a data integrity risk, such as when neighboring WLs are being accessed more frequently than once per 100-200 microseconds. The SCR control system 142 may also disable SCR mode when sequential reads are interrupted by reads to other WLs in different blocks or SBs, when the frequency of neighboring WL accesses exceeds thresholds that could risk data integrity, or when the NAND firmware overrides SCR enable commands to protect data integrity.

The flowchart 600 demonstrates how the SCR control system 142 optimizes read performance by identifying sequential patterns, evaluating SCR mode conditions, and controlling WL voltage states while protecting data integrity. This is particularly beneficial for AI workloads involving large volumes of interleaved sequential reads during model loading.

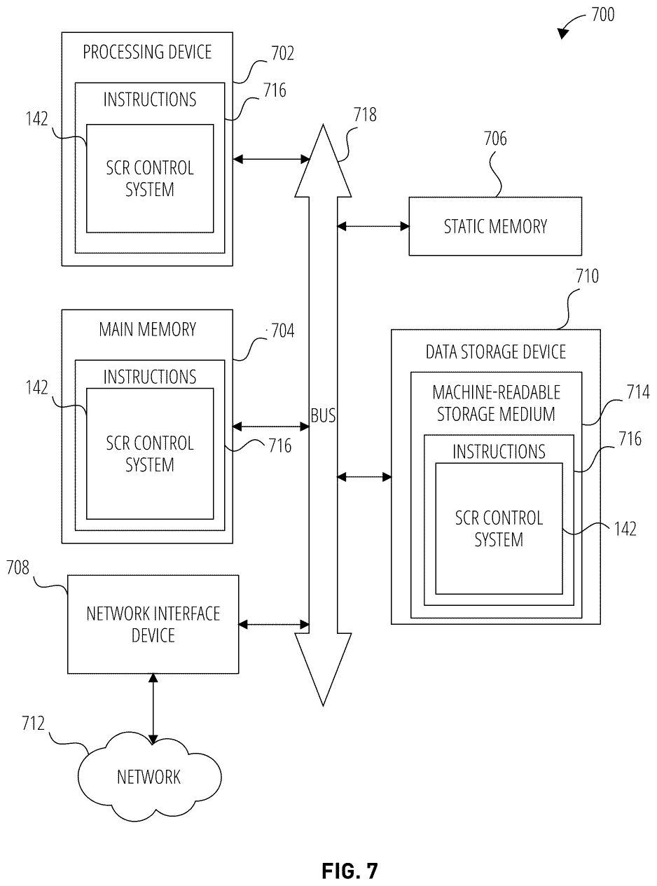

FIG. 7 illustrates an example machine in the form of a computer system 700 within which a set of instructions can be executed for causing the machine to perform any one or more of the methodologies discussed herein. In some examples, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., ROM, flash memory, DRAM such as SDRAM or Rambus DRAM (RDRAM), etc.), a static memory 706 (e.g., flash memory, static random access memory (SRAM), etc.), and a data storage device 710, which communicate with each other via a bus 718.

The processing device 702 represents one or more general-purpose processing devices such as a microprocessor, a central processing unit, or the like. More particularly, the processing device 702 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 702 can also be one or more special-purpose processing devices such as an application-specific integrated circuit (ASIC), a field programmable gate array (FPGA), a digital signal processor (DSP), a network processor, or the like. The processing device 702 is configured to execute instructions 716 for performing the operations and steps discussed herein. The computer system 700 can further include a network interface device 708 to communicate over a network 712.

The data storage device 710 can include a machine-readable storage medium 714 (also known as a computer-readable medium) on which is stored one or more sets of instructions 716 or software embodying any one or more of the methodologies or functions described herein. The instructions 716 can also reside, completely or at least partially, within the main memory 704 and/or within the processing device 702 during execution thereof by the computer system 700, the main memory 704 and the processing device 702 also constituting machine-readable storage media. The machine-readable storage medium 714, data storage device 710, and/or main memory 704 can correspond to the memory sub-system 110 of FIG. 1.

While the machine-readable storage medium 714 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1. A system comprising: a memory device of a memory sub-system, the memory device having a SCR mode, the SCR mode, when enabled, maintaining a WL of the memory device in a ramped-up state for sequential read commands directed to that WL; and a processing device, coupled to the memory device, programmed to perform operations comprising: identifying and tracking multiple concurrent sequential read streams from read commands directed to the memory device; determining whether at least one of the multiple concurrent sequential read streams satisfies an SCR mode condition based on analyzing read patterns of the read commands; and controlling activation of the SCR mode in the memory device for the at least one of the multiple concurrent sequential read streams in response to determining whether the SCR mode condition is satisfied.

Example 2. The system of Example 1, wherein operations of the SCR mode comprise: maintaining a voltage of the WL in the ramped-up state for sequential reads to multiple locations of an entirety of the WL including at least one of a plurality of sub-blocks or an entire memory block; and ramping down the voltage of the WL after at least one of completing reads to all pages of the WL, switching to a different WL, or disabling the SCR mode.

Example 3. The system of any one of Examples 1-2, wherein identifying and tracking the multiple concurrent sequential read streams comprises: maintaining a queue that stores data associated with each stream including last n physical block addresses (PBAs); implementing an eviction policy to track a limited number of most recent or most common streams; and applying one or more criteria to assign incoming PBAs to existing streams or identify new streams based on sequential patterns.

Example 4. The system of any one of Examples 1-3, wherein determining whether the SCR mode condition is satisfied comprises: analyzing whether multiple read commands are directed to a same WL in a group of subblocks (SBs) on a same die plane; and determining whether the read commands follow a sequential pattern within a defined threshold.

Example 5. The system of Example 4, wherein determining whether the read commands follow the sequential pattern within the defined threshold comprises: setting a threshold value that defines a maximum number of previous physical block addresses (PBAs) to analyze for determining sequential patterns; analyzing previous PBAs within the threshold value to: detect sequential access patterns despite gaps or interruptions in the sequential patterns, and determine whether skips between PBAs are within an acceptable range for maintaining sequential status; and enabling the SCR mode when the sequential patterns are detected within the analyzed previous PBAs, wherein the threshold value is adjusted based on at least one of frequency of current sequential read commands or potential time and energy savings from enabling the SCR mode.

Example 6. The system of any one of Examples 4-5, the operations comprising: evaluating potential time and energy savings from enabling the SCR mode in response to determining that the read commands follow the sequential pattern within the defined threshold; and determining that the SCR mode condition is satisfied in response to determining that the potential time and energy savings satisfy certain criteria.

Example 7. The system of any one of Examples 1-6, wherein controlling the activation of the SCR mode comprises: enabling the SCR mode for a first command in a sequential read sequence; maintaining the SCR mode when sequential reads are temporarily interrupted by reads to other WLs; and disabling the SCR mode in response to determining that a threshold amount of time has elapsed since a last sequential read of the sequential read sequence has been performed or in response to determining that maintaining the SCR mode in an enabled state is associated with data loss.

Example 8. The system of any one of Examples 1-7, the operations comprising: storing sequential data in SCR-block chunks, wherein: an initial sequence of logical block addresses (LBAs) comprises interleaved sequential streams with gaps and random reads; and the sequential data is stored in a command queue without interruption by random reads; coalescing host read commands in the command queue into SCR-block sized chunks by: separating the interleaved sequential streams; reordering commands within each stream to create sequential address sequences corresponding to a same WL; inserting supplemental read commands to maintain sequential patterns; and combining the reordered commands into a coalesced sequence.

Example 9. The system of any one of Examples 1-8, the operations comprising: reordering read commands to combine sequential reads from different streams; filling gaps in physical block address sequences with dummy read commands; and sending the reordered read commands to the memory device to maintain sequential access patterns.

Example 10. The system of any one of Examples 1-9, the operations comprising: sending one or more commands to the memory device to enable or disable the SCR mode based on determining whether the at least one of the multiple concurrent sequential read streams satisfies the SCR mode condition; receiving status information indicating a current SCR mode state from the memory device; and allowing the memory device to override SCR enable commands to protect data integrity.

Example 11. The system of any one of Examples 1-10, the operations comprising: determining that the read patterns of the read commands correspond to machine learning model loading traffic patterns corresponding to the SCR mode condition; and enabling the SCR mode in response to determining that the read patterns of the read commands correspond to the machine learning model loading traffic patterns.

Example 12. The system of any one of Examples 1-11, the operations comprising: receiving one or more hints from a host system indicating sequential data that needs to be read sequentially; defragmenting files to create sequential logical block address ranges; and maintaining sequential alignment during garbage collection.

Example 13. The system of Example 12, the operations comprising: writing sequential data to the memory device by storing the sequential data in SCR-block chunks based on block size for memory type.

Example 14. The system of any one of Examples 12-13, the operations comprising: maintaining sequential data layout during write operations by: using the one or more hints to identify the sequential data that needs to be read sequentially; writing the identified sequential data without interruption by random writes; and preserving sequential alignment during garbage collection and folding operations.

Example 15. The system of any one of Examples 12-14, the operations comprising: gathering and reordering scattered sequential data by: using timestamps to identify continuous sequential data streams; scatter gathering a specified amount of sequential read data during garbage collection; and reordering the sequential data to align with SCR block boundaries.

Example 16. The system of any one of Examples 1-15, wherein controlling the activation comprises: tracking timing of sequential read commands; monitoring neighboring WL read activity; and disabling SCR mode to protect data integrity when neighboring WLs are frequently accessed.

Example 17. The system of any one of Examples 1-16, wherein the processing device comprises a memory sub-system controller, a host system, or a local media controller.

Example 18. The system of any one of Examples 1-17, wherein the memory device comprises a 3D NAND device.

Example 19. The system of any one of Examples 1-18, wherein the operations further comprise: activating the SCR mode for multiple WLs of the memory device to maintain the multiple WLs of the memory device simultaneously in the ramped-up state in response to identifying multiple concurrent sequential read streams directed to the different WLs, wherein: the multiple concurrent sequential read streams comprise: a first sequential read stream directed to a first WL; and a second sequential read stream directed to a second WL; and the processing device maintains both the first WL and the second WL simultaneously in the ramped-up state while performing sequential reads from the first sequential read stream and the second sequential read stream.

Example 20. At least one non-transitory machine-readable storage medium comprising instructions that, when executed by a processing device, cause the processing device to perform operations comprising: identifying and tracking multiple concurrent sequential read streams from read commands directed to a memory device, the memory device having a SCR mode, the SCR mode, when enabled, maintaining a WL of the memory device in a ramped-up state for sequential read commands directed to that WL; determining whether at least one of the multiple concurrent sequential read streams satisfies an SCR mode condition based on analyzing read patterns of the read commands; and controlling activation of the SCR mode in the memory device for the at least one of the multiple concurrent sequential read streams in response to determining whether the SCR mode condition is satisfied.

Example 21. A method comprising: identifying and tracking multiple concurrent sequential read streams from read commands directed to a memory device, the memory device having a SCR mode, the SCR mode, when enabled, maintaining a WL of the memory device in a ramped-up state for sequential read commands directed to that WL; determining whether at least one of the multiple concurrent sequential read streams satisfies an SCR mode condition based on analyzing read patterns of the read commands; and controlling activation of the SCR mode in the memory device for the at least one of the multiple concurrent sequential read streams in response to determining whether the SCR mode condition is satisfied.

The term “coupled with” generally refers to a connection between components, which can be an indirect communicative connection or direct communicative connection (e.g., without intervening components), whether wired or wireless, including connections such as electrical, optical, magnetic, and the like.

“System data” hereinafter refers to data that is created and/or maintained by the memory sub-system for performing operations in response to host requests and for media management.

“User data” hereinafter generally refers to host data and garbage collection data.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader scope of examples of the disclosure as set forth in the following claims. The specification and drawings are, accordingly, to be regarded in an illustrative sense rather than a restrictive sense.

1. A system comprising:
a memory device of a memory sub-system, the memory device having a seamless cache read (SCR) mode, the SCR mode, when enabled, maintaining a wordline (WL) of the memory device in a ramped-up state for sequential read commands directed to that WL; and
a processing device, coupled to the memory device, programmed to perform operations comprising:
identifying and tracking multiple concurrent sequential read streams from read commands directed to the memory device;
determining whether at least one of the multiple concurrent sequential read streams satisfies an SCR mode condition based on analyzing read patterns of the read commands;
controlling activation of the SCR mode in the memory device for the at least one of the multiple concurrent sequential read streams in response to determining whether the SCR mode condition is satisfied;
enabling the SCR mode for a first command in a sequential read sequence;
maintaining the SCR mode when sequential reads are temporarily interrupted by reads to other WLs; and
disabling the SCR mode in response to determining that a threshold amount of time has elapsed since a last sequential read of the sequential read sequence has been performed or in response to determining that maintaining the SCR mode in an enabled state is associated with data loss.

2. The system of claim 1, wherein operations of the SCR mode comprise:
maintaining a voltage of the WL in the ramped-up state for sequential reads to multiple locations of an entirety of the WL including at least one of a plurality of sub-blocks or an entire memory block; and
ramping down the voltage of the WL after at least one of completing reads to all pages of the WL, switching to a different WL, or disabling the SCR mode.

3. The system of claim 1, wherein identifying and tracking the multiple concurrent sequential read streams comprises:
maintaining a queue that stores data associated with each stream including last n physical block addresses (PBAs);
implementing an eviction policy to track a limited number of most recent or most common streams; and
applying one or more criteria to assign incoming PBAs to existing streams or identify new streams based on sequential patterns.

4. The system of claim 1, wherein determining whether the SCR mode condition is satisfied comprises:
analyzing whether multiple read commands are directed to a same WL in a group of subblocks (SBs) on a same die plane; and
determining whether the read commands follow a sequential pattern within a defined threshold.

5. The system of claim 4, wherein determining whether the read commands follow the sequential pattern within the defined threshold comprises:
setting a threshold value that defines a maximum number of previous physical block addresses (PBAs) to analyze for determining sequential patterns;
analyzing previous PBAs within the threshold value to:
detect sequential access patterns despite gaps or interruptions in the sequential patterns, and
determine whether skips between PBAs are within an acceptable range for maintaining sequential status; and
enabling the SCR mode when the sequential patterns are detected within the analyzed previous PBAs, wherein the threshold value is adjusted based on at least one of frequency of current sequential read commands or potential time and energy savings from enabling the SCR mode.

6. The system of claim 4, the operations comprising:
evaluating potential time and energy savings from enabling the SCR mode in response to determining that the read commands follow the sequential pattern within the defined threshold; and
determining that the SCR mode condition is satisfied in response to determining that the potential time and energy savings satisfy certain criteria.

7. The system of claim 1, the operations comprising:
storing sequential data in SCR-block chunks based on block size for memory type, wherein for single level cell blocks an SCR-block size is a specified amount across multiple sub-blocks and for tri-level cell blocks the SCR-block size is a larger specified amount.

8. The system of claim 1, the operations comprising:
storing sequential data in SCR-block chunks, wherein:
an initial sequence of logical block addresses (LBAs) comprises interleaved sequential streams with gaps and random reads; and
the sequential data is stored in a command queue without interruption by random reads; and
coalescing host read commands in the command queue into SCR-block sized chunks by:
separating the interleaved sequential streams;
reordering commands within each stream to create sequential address sequences corresponding to a same WL;
inserting supplemental read commands to maintain sequential patterns; and
combining the reordered commands into a coalesced sequence.

9. The system of claim 1, the operations comprising:
reordering read commands to combine sequential reads from different streams;
filling gaps in physical block address sequences with dummy read commands; and
sending the reordered read commands to the memory device to maintain sequential access patterns.

10. The system of claim 1, the operations comprising:
activating the SCR mode for multiple WLs of the memory device to maintain the multiple WLs of the memory device simultaneously in the ramped-up state;
monitoring power consumption associated with maintaining the multiple WLs of the memory device in the ramped-up state; and
implementing throttling in response to the power consumption to stay within power budget constraints.

11. The system of claim 1, the operations comprising:
determining that the read patterns of the read commands correspond to machine learning model loading traffic patterns corresponding to the SCR mode condition; and
enabling the SCR mode in response to determining that the read patterns of the read commands correspond to the machine learning model loading traffic patterns.

12. The system of claim 1, the operations comprising:
receiving one or more hints from a host system indicating sequential data that needs to be read sequentially;
defragmenting files to create sequential logical block address ranges; and
maintaining sequential alignment during garbage collection.

13. The system of claim 12, the operations comprising:
writing sequential data to the memory device by storing the sequential data in SCR-block chunks based on block size for memory type.

14. The system of claim 12, the operations comprising:
maintaining a sequential data layout during write operations by:
using the one or more hints to identify the sequential data that needs to be read sequentially;
writing the identified sequential data without interruption by random writes; and
preserving sequential alignment during garbage collection and folding operations.

15. The system of claim 12, the operations comprising:
gathering and reordering scattered sequential data by:
using timestamps to identify continuous sequential data streams;
scatter-gathering a specified amount of sequential read data during garbage collection; and
reordering the sequential data to align with SCR block boundaries.

16. The system of claim 1, wherein controlling the activation comprises:
tracking timing of sequential read commands;
monitoring neighboring WL read activity; and
disabling SCR mode to protect data integrity when neighboring WLs are frequently accessed.

17. The system of claim 1, wherein the operations further comprise:
activating the SCR mode for multiple WLs of the memory device to maintain the multiple WLs of the memory device simultaneously in the ramped-up state in response to identifying multiple concurrent sequential read streams directed to the different WLs, wherein: the multiple concurrent sequential read streams comprise: a first sequential read stream directed to a first WL; and
a second sequential read stream directed to a second WL; and
the processing device maintains both the first WL and the second WL simultaneously in the ramped-up state while performing sequential reads from the first sequential read stream and the second sequential read stream.

18. The system of claim 1, wherein the memory device comprises a three-dimensional (3D) NAND device.

19. A host system comprising:
processor chipset programmed to perform operations comprising:
sending read commands to a memory sub-system, the memory sub-system comprising a memory device having a seamless cache read (SCR) mode, the SCR mode, when enabled, maintaining a wordline (WL) of the memory device in a ramped-up state for sequential read commands directed to that WL;
receiving one or more hints indicating sequential data that needs to be read sequentially;
defragmenting files to create sequential logical block address ranges;
sending one or more commands to the memory sub-system to enable the SCR mode for a first command in a sequential read sequence; and
sending one or more commands to the memory sub-system to disable the SCR mode in response to determining that a threshold amount of time has elapsed since a last sequential read of the sequential read sequence has been performed or in response to determining that maintaining the SCR mode in an enabled state is associated with data loss.

20. A method comprising:
identifying and tracking multiple concurrent sequential read streams from read commands directed to a memory device, the memory device having a seamless cache read (SCR) mode, the SCR mode, when enabled, maintaining a wordline (WL) of the memory device in a ramped-up state for sequential read commands directed to that WL;
determining whether at least one of the multiple concurrent sequential read streams satisfies an SCR mode condition based on analyzing read patterns of the read commands;
controlling activation of the SCR mode in the memory device for the at least one of the multiple concurrent sequential read streams in response to determining whether the SCR mode condition is satisfied;
sending one or more commands to the memory device to enable or disable the SCR mode based on determining whether the at least one of the multiple concurrent sequential read streams satisfies the SCR mode condition;
receiving status information indicating a current SCR mode state from the memory device; and
allowing the memory device to override SCR enable commands to protect data integrity.
